(19) United States
(12) Patent Application Publication
(10) Pub. No.: US 2026/0004177 A1
(43) Pub. Date: Jan. 1, 2026

(54) QUANTUM DESIGN AUTOMATION SYSTEM

(71) Applicant: Quantum Elements Inc., Palo Alto, CA (US)

(72) Inventors: Dor Gabay, Jacksonville, FL (US); Daniel Lidar, La Canada, CA (US); Amir Yacoby, Newton, MA (US); Izhar Medalsy, Thousand Oaks, CA (US)

(21) Appl. No.: 18/652,578

(22) Filed: May 1, 2024

Related U.S. Application Data
(60) Provisional application No. 63/499,877, filed on May 3, 2023.
(60) Provisional application No. 63/515,456, filed on Jul. 25, 2023.

(51) Int. Cl. G06N 10/60; G06N 10/20

(52) U.S. Cl. CPC G06N 10/60; G06N 10/20

(57) ABSTRACT

A quantum design automation (QDA) system provides developers means to ensure maximal performance, reliability, and enhancement of simulated qubit architectures or quantum circuits. The system generates performance metrics for qubit operations applied to a qubit architecture and optimizes control signals applied thereto to maximize the performance metrics. An OQS simulator determines the performance metrics of a user-prescribed effective Hamiltonian. A quantum control module iteratively runs the OQS simulator to optimize the control signals and maximize the performance metrics for a prescribed cost function. The effective Hamiltonian is defined by a system Hamiltonian describing the individual qubits, interaction Hamiltonian articulating the interactions of sets of qubits, a bath Hamiltonian describing any environmental noise sources, and a system-bath coupling Hamiltonian describing the interaction of the system with the bath. The system provides both software and hardware developers analysis and verification tools to refine system designs and quantum circuits on selected qubit architectures.

### RELATED APPLICATIONS

This is a NONPROVISIONAL and claims the priority benefit of U.S. Provisional Application No. 63/499,877, filed May 3, 2023, and U.S. Provisional Application No. 63/515,456, filed Jul. 25, 2023, each of which is incorporated herein by reference in its entirety.

### FIELD OF THE INVENTION

The present invention relates to systems and methods for the analysis, synthesis, and verification of quantum computing architectures.

### BACKGROUND

A quantum computer is a computing device that exploits quantum mechanical phenomena in its operation. It is generally believed that quantum computers are better suited to some computational tasks than conventional computers that do not exploit these phenomena. One hallmark of quantum computers is that their basic unit of information is the qubit, which, unlike conventional bits familiar to users of conventional computers, can exist in a superposition of states. By exploiting this and other properties, such as quantum entanglement, quantum computers are able to perform certain calculations that cannot feasibly be performed by conventional computers in an efficient manner.

In quantum computing, software developers commonly speak of quantum algorithms. A quantum algorithm is an algorithm, that is, a sequence of instructions or procedures (e.g., logical gates) for solving a particular problem, that runs on a quantum computer. Well-known quantum algorithms include Shor's algorithm for factoring integers and Grover's algorithm for searching unstructured databases.

Just as with conventional computers, for which computer programs (algorithms) must be expressed as a sequence of low-level machine instructions, quantum algorithms must be expressed as sequences of quantum operations to be performed on quantum computers. These quantum operations are typically described using circuit models of quantum computation (so-called quantum circuits), which represent operations to be performed on a set of qubits that make up the quantum computer. “Programming” a quantum computer thus takes the form of writing and subsequently compiling a quantum algorithm for execution on a particular platform made up of qubits. This is, presently, a very time consuming and somewhat imprecise process. Among the difficulties that exist are a lack of available simulators to reliably predict how various qubit-based platforms will execute a particular quantum algorithm on existing qubit architectures, and a lack of analysis and verification tools for hardware designers to adequately characterize quantum hardware platforms at the design stage.

### SUMMARY OF THE INVENTION

According to one embodiment of the present invention, a quantum design automation (QDA) system is configured to provide a set of performance metrics for each of a plurality of qubit operations of a specified qubit architecture from an effective Hamiltonian for the specified qubit architecture and to additionally provide a set of control signals for the specified qubit architecture which maximize the performance metrics for a prescribed cost function based on one or more of the performance metrics. For example, the QDA system may include a processor communicatively coupled to a memory, where the memory stores processor-executable instructions, which instruction when executed by the processor cause the processor to perform such actions. The effective Hamiltonian for the prescribed qubit architecture may be produced by specifying the placement and routing components of the prescribed qubit architecture, assigning coefficient values preceding an operator basis expansion of a chosen operator basis representation, assigning time-dependent coefficients within the operator basis expansion for application of the qubit operations, allocating relevant undesired crosstalk terms to the routing components, and choosing any relevant noise sources and assigning their respective noise model parameters. These coefficients and parameters may be entered, for example, via a user interface of the QDA system. The present QDA system may further be configured to provide for selection of one or more characterized qubit architectures from a library of qubit architectures and to facilitate simulated execution of a quantum algorithm on selected ones of the qubit architectures from the library. The executed simulation can then be used to produce performance metrics which can be used for the analysis, synthesis, and verification of the qubit architecture(s) or quantum algorithm(s).

In various embodiments, the performance metrics are produced by an open quantum system simulator that is configured to input a set of coefficients contained within the effective Hamiltonian. For example, the open quantum system simulator may be a master equation that is propagated using an arbitrary time-dependent Hamiltonians with a variety of noise sources. In some instances, the open quantum system simulator is configured to determine the performance metrics of the qubit architecture using an Open Quantum Systems framework computationally accelerated by one or more of tensor networks (TN), Quantum Monte Carlo (QMC), and sparse or matrix-free representation. And, the open quantum system simulator may incorporate one or more noise models, e.g., 1/f charge noise, spin bath, and Ohmic bath. Additionally, the control signals may be optimized according to one or more quantum control protocols, for example, Chopped RAndom Basis (CRAB), GRadient Ascent Pulse Engineering (GRAPE), and Krylov subspace approach. In some instances, the open quantum system simulator may be characterized for the specified qubit architecture by using machine learning and fitting procedures to, for example, prescribe an appropriate master equation(s), fine tune the qubit architecture's noise model parameters, and define an appropriate bond dimension, D, for TN schemes.

These and further embodiments and features of the present QDA system are described in greater detail below.

### BRIEF DESCRIPTION OF THE DRAWINGS

The present invention is illustrated by way of example, and not limitation, in the figures of the accompanying drawings, in which:

FIG. 1 illustrates an end-to-end stack of the different modules of a quantum design automation (QDA) system according to an embodiment of the invention, which includes a system input module for defining a quantum computing architecture, an effective modeling stage for creating an effective Hamiltonian characterizing the system, an open quantum system simulator stage for attaining performance metrics using an appropriate master equation and prescribed noise models, a system characterization stage for fine tuning the open quantum system simulator towards a particular quantum system, a quantum control module for prescribing optimized control signals for a subject quantum system, and analysis and verification tools for checking system reliability and modifying the system design.

FIGS. 2A-2C are schematic representations of how a system input that needs to be defined by the hardware developer can be categorized into three steps: FIG. 2A, showing placement and configuration of components, such as qubits and their interconnects, for a given quantum computing architecture; FIG. 2B, showing prescription of coefficients preceding the operator basis expansion for a given operator basis representation, here defined by the Pauli operator basis representation; and FIG. 2C, showing incorporation of relevant noise sources and their respective noise model parameters.

FIG. 3 is a plot demonstrating runtimes as a function of system size (qubit number) for solving the stochastic Schrodinger equation using the ITensor library as part of evaluation of a Time-Evolving Block Decimation (TEBD) algorithm according to an embodiment of the invention.

FIG. 4 illustrates an example of an environment in which embodiments of the present QDA system may be instantiated, deployed, and used.

FIGS. 5A-5G illustrate examples of user interface screens for a QDA system such as that shown in FIG. 1.

### DETAILED DESCRIPTION

The present inventors have devised apparatus and methods for the analysis, synthesis, and verification of quantum computing architectures. These apparatus and methods are embodied, in one example, in a QDA system. The QDA system serves as a bridge between the faulty quantum computing architectures of hardware developers and the idealistic logical circuit designs of software developers.

For the hardware developer, the QDA system allows the developer to use open quantum system simulators, or quantum simulators, to analyze the performance of a qubit-based system design (e.g., a quantum computer architecture) described by an effective Hamiltonian, along with any relevant control conditions and noise sources. In other words, the QDA system allows the hardware developer to verify that the developer's qubit-based system would (indeed, does) perform in an appropriate, or expected, fashion for different logical instances. In some cases, this may entail enhancing various performance metrics of an existing qubit-based system by optimizing the design and/or control signals thereof.

For the software developer, the QDA system allows the developer to verify and optimize quantum circuit representations of quantum algorithms for one or more different qubit-based platforms and/or identify one or more such platforms for which their algorithms best operate. Examples for such optimizations are discussed below. Given specified qubit architectures with defined interconnects, the software developer can more accurately map logical quantum circuit representations of quantum algorithms onto those architectures. This mapping may entail finding an optimal assignment of logical qubits of a given architecture to elements of the quantum circuit, with the aim being to maximize performance metrics of the resulting construct. Again, the open quantum system simulators of the present QDA system can be iteratively employed to arrive at such a set of optimized performance metrics. By allowing the software developer to not only explore different qubit-based architectures, but also, for each such architecture, to determine an optimal employment of thereof for a specified quantum algorithm, the present QDA system can greatly enhance the software developer's algorithm design process and qubit architecture selection.

One important feature of the present QDA system is that it is qubit-type agnostic. That is, it can simulate any form of qubit-based system, whether the system employs superconducting qubits, photonic qubits, semiconductor-based qubits, Rydberg atom qubits, trapped ion qubits, defect-based qubits, or other qubit types. As explained below, qubit type is abstracted through an input interface that allows the qubits and their interrelationships to be defined by placement and routing components, thus facilitating the universal applicability of the present QDA system.

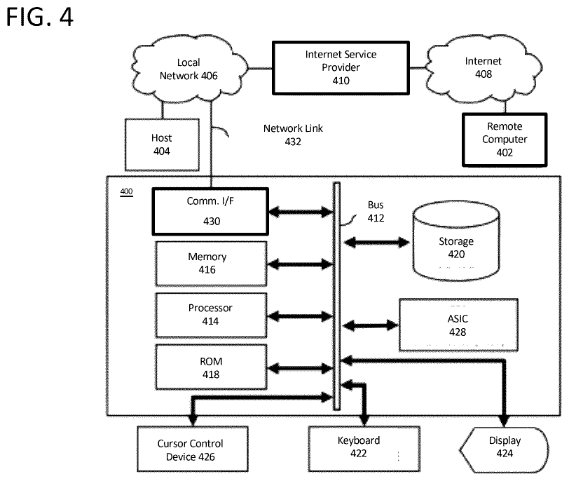

Before describing further details of the present QDA system, it is helpful to discuss an environment in which embodiments thereof may be instantiated, deployed, and used. FIG. 4 illustrates an example of such an environment. In this arrangement, a computer system 400, which hosts an instance of the present QDA system, is programmed via stored processor-executable instructions to interact with a remote computer system 402 used by a hardware or software developer, e.g., over the Internet 408 through the facilities of an Internet Service Provider 410. In one embodiment, remote computer system 402 acts as a client to computer system 400, which acts as a server and is programmed to allow a user at remote computer 402 to characterize and/or optimize an existing qubit-based system, store and retrieve instances of such designs, and/or verify and optimize quantum circuit representations of quantum algorithms for different qubit-based platforms and identify one or more such platforms for which various algorithms best operate. In such an arrangement, computer system 400, that is, the present QDA system, is used by remote computer system 402 as a service-as-a-platform, and a user interacts with the QDA system running on computer system 400 via a web browser or other client application running on computer system 402. Alternatively, or in addition, the facilities for any or all of the above uses may be accessed and executed locally on computer system 400 via human-machine interfaces described below, and/or those of a local host 404 communicatively coupled to computer system 400 over a local network 406.

As illustrated, computer system 400 generally includes a communication mechanism such as a bus 412 for passing information, e.g., data and/or instructions, between various components of the system, including one or more processors 414 for processing the data and instructions. Processor(s) 414 perform(s) operations on data as specified by the stored computer programs on computer system 400, such as stored computer programs for performing the operations of the present QDA system. The stored computer programs for computer system 400 may be written in any convenient computer programming language and then compiled into native instructions for the processor(s) 414.

Computer system 400 also includes a memory 416, such as a random access memory (RAM) or any other dynamic storage device, coupled to bus 412. Memory 416 stores information, including processor-executable instructions, data, and temporary results, for performing the operations described herein. That is, the processor-executable instructions stored in memory 416, when executed by processor(s) 414, cause the processor(s) to perform the operations described herein. Computer system 400 also includes a read only memory (ROM) 418 or any other static storage device coupled to the bus 412 for storing static information, including processor-executable instructions, that is not changed by the computer system 400 during its operation. Also coupled to bus 412 is a non-volatile (persistent) storage device 420, such as a magnetic disk, optical disk, solid-state drive, or similar device for storing information, including processor-executable instructions, that persists even when the computer system 400 is turned off. Storage device 420 may also store instances of qubit platform architectures to be used by software developers as described herein. Memory 416, ROM 418, and storage device 420 are examples of a non-transitory “computer-readable medium.”

Computer system 400 also optionally includes human interface elements, such as a keyboard 422, display 424, and cursor control device (e.g., a mouse or trackpad) 426, each of which is coupled to bus 412. These elements allow a human user to interact with and control the operation of computer system 400 locally. For example, these human interface elements may be used for controlling a position of a cursor on the display 424 and issuing commands associated with graphical and/or command line elements presented thereon. In the illustrated example of computer system 400, special purpose hardware, such as an application specific integrated circuit (ASIC) 428, is coupled to bus 412 and may be configured to perform operations not performed by processor 414; for example, ASIC 428 may be a graphics accelerator unit for generating images for display 424.

To facilitate communication with external devices, computer system 400 also includes a communications interface 430 coupled to bus 412. Communication interface 430 provides bi-directional communication with remote computer systems such as computer system 402 and host 404 over a wired or wireless network link 432 that is communicably connected to local network 406 and ultimately, through ISP 410, to Internet 408. It is also contemplated that components of an overall system can be deployed in various configurations within one or more computer systems.

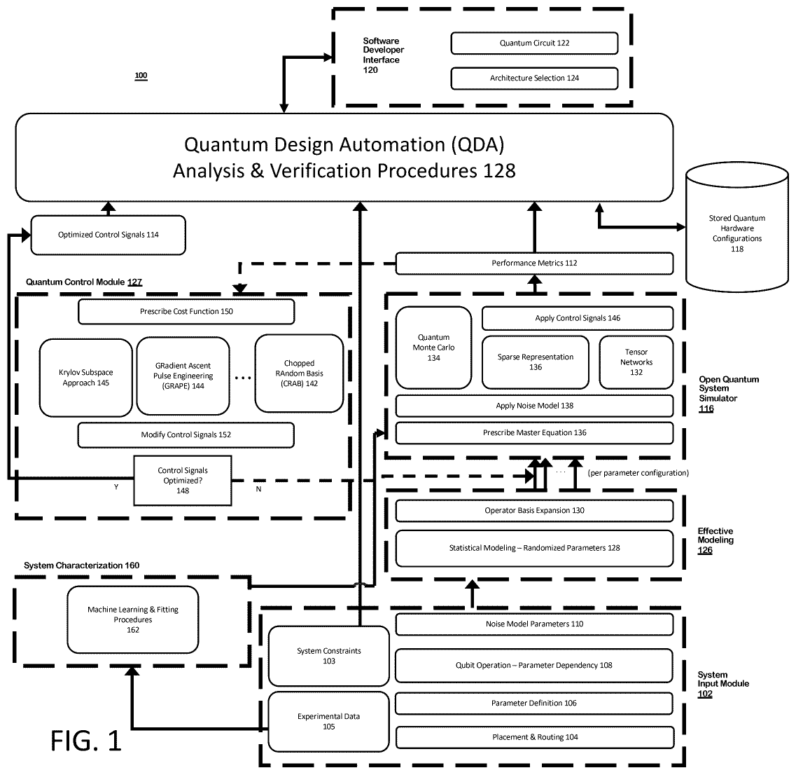

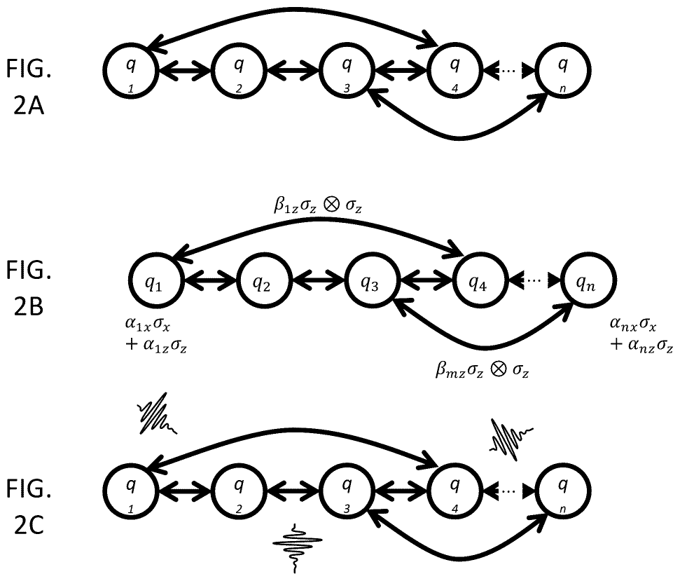

With the above in mind, reference is now made to FIG. 1. QDA system 100 includes an input module (e.g., a user interface) 102 that accepts (e.g., from a hardware developer) as input: (1) the qubit architecture's placement and routing components 104; (2) coefficient values 106 of the operator basis expansion for a prescribed operator basis representation; (3) time-dependent coefficients 108 of the operator basis expansion for the application of qubit operations; (4) crosstalk terms relevant to any of the routing components; and (5) relevant noise sources and their respective noise model parameters. One example of an operator basis representation is the Pauli group operators, with the operator basis defined by the Pauli operators. As illustrated in FIG. 2A, the placement and routing components describe the design of the user's qubit architecture. In particular, the placement components describe individual qubits (q₁, q₂, q₃, . . . qₙ) while the routing components (illustrated as line segments between the individual qubits) describe the interaction between a set of placement components. Each of these components is defined by an effective Hamiltonian containing coefficients that precede Pauli group operators (FIG. 2B). A mean value is prescribed to each coefficient, along with an optional variation in the coefficient value due to material defects, fabrication defects, and/or other possible causes. A set of control signals is then specified for each qubit operation. Each control signal contains a set of time-dependent coefficients within the operator basis expansion that must be characterized prior to running open quantum system simulations. Finally, relevant noise sources are chosen and the set of parameters within their respective noise models 110 are specified (FIG. 2C). Note, aside from the noise model parameters, these inputs are not required if a developer already has an effective Hamiltonian for a given qubit architecture, in which case that effective Hamiltonian can be used directly by the open quantum system simulator, as discussed below.

Returning to FIG. 1, once the system input is defined for a given qubit architecture (if needed), the quantum simulator outputs a set of performance metrics 112 for each qubit operation. One example of such a performance metric is a fidelity map of a given qubit operation (i.e., a map of fidelity specified for every possible qubit operation within the qubit architecture). Here, fidelity refers to a measure of the “closeness” of two quantum states; it expresses the overlap (absolute value of the scalar product for pure states) between the two states. Further, if the quantum control procedure is enabled, a set of optimal control signals 114 are generated. This may entail iteratively running 148 candidate control signals over the open quantum system simulator 116 via control signal application process 146. For each iteration, the performance metrics produced by open quantum system simulator 116 are assessed according to a prescribed cost function 150, the control signals modified 152, and a determination made as to whether an optimal set of performance metrics has been achieved.

The input module 102 may be configured to allow the user to optimize the placement and routing components of their qubit architecture, given a set of constraints 103. For hardware developers, these constraints may include routing coefficients, placement coefficients, upper/lower thresholds of specified control signals, or qubit noise model parameters, while for software developers this may, for example, include upper limits on circuits depth and circuit width. Among the optimizations that may be determined are optimizations for optimal routing configuration of the user's system design given the set of specified constraints.

To aid in software development, the present QDA system facilitates the study of quantum circuit designs within various qubit systems, e.g., fully connected systems in which each qubit is connected to every other qubit. In such scenarios, a set of coefficients preceding the Pauli group operators can either be predefined or specified by the user. For ideal calculations, components can be assumed identical with no variation in coefficient values. For a more comprehensive study, noise sources can be paired to specific qubit architectures along with a set of defined noise model parameters. For an advanced analysis, the performance of proposed quantum circuits may be simulated on previously stored quantum computing architectures. Stored system design specifications within a database 118 may be browsed via an architecture selection facility 124 and one or more desired architectures selected so that software developers can choose those architectures on which to simulate their proposed quantum circuit designs. This reduces or eliminates the need for software developers to acquire domain knowledge of specific quantum computing platforms and instead treat the simulator as a quantum-simulation-as-a-service (QSaaS) cloud infrastructure for the purpose of circuit design and validation.

To make use of such facilities, quantum software developers are provided a user interface 120 through which they may provide specifications of a proposed quantum circuit 122 and specify the quantum computing architecture(s) of interest 124 from a library of such architectures 118. A set of performance metrics will then be determined for the specified quantum computing architecture(s) according to qubit operations specified by the quantum circuit. Finally, analysis and verification protocols will allow the users to determine the validity of their quantum circuits prior to running them on actual quantum computing hardware.

With the above overview completed, further details of the QDA system 100 may be described. As mentioned, hardware developers may use input module 102 to specify the design of a qubit architecture. With such inputs, an effective modeling stage 126 creates an effective Hamiltonian composed of the user-prescribed coefficients. Thereafter, an open quantum system simulator 116 generates performance metrics 112 from a constructed effective Hamiltonian model for the set of user-prescribed control signals and noise sources. Prior to running simulations, system characterization 160 can optionally be used to ensure that the open quantum system simulator properly characterizes the qubit architecture under consideration. Following simulations, defining a sufficient set of performance metrics 112 is important so as to provide the user with a reliable understanding of the subject quantum component(s) and/or quantum circuit. Accurate performance metrics can also ensure more reliable quantum control protocols. Among the more easily measurable metrics are the energy relaxation and dephasing times, also known as transverse and longitudinal relaxation times. The most common metric is the fidelity, typically used to assess the success probability of initialization, readout, one-qubit operations, and two-qubit operations. An equivalent metric is the trace-norm distance. The two metrics (fidelity and distance) provide mutual upper and lower bounds. Randomized benchmarking is a relatively efficient method to experimentally estimate the fidelity, at the cost of not being able to capture non-Markovian effects due to the randomized nature of this approach. This set of metrics tries to capture performance in terms of a single number. At the other extreme is quantum state or process tomography, which gives complete information about the output state or gate operation. The number of measurements required for tomography scales exponentially in the number of qubits. Randomized benchmarking can be extended to incorporate gate set tomography, which provides a less costly approach to performing tomography. Another useful and less costly approach is quantum compressed sensing. Once performance metrics have been obtained, a quantum control module 127 is then used to refine the control signals of the qubit architecture by iterating over the open quantum system simulator module 116. Finally, analysis and verification procedures 128 can be used to automate hardware design and assess circuit performance on the proposed quantum computing architectures.

Effective Modeling: In the effective modeling stage 126, an effective Hamiltonian to be simulated at the open quantum system modeling stage 116 is constructed. The effective Hamiltonian acts on the 2^{N} dimensional space of N qubits and is typically described by a Pauli operator basis. At first, the collection of coefficients prescribed to the Pauli operators within the graphical representation of FIG. 2 are used to define an effective Hamiltonian. The effective Hamiltonian for the specified qubit architecture is defined by the sum of: (i) a system Hamiltonian constructed by the tensor product of the operator basis expansion of N qubits; (ii) an interaction Hamiltonian constructed by the sum of all drive and qubit-qubit interaction Hamiltonians describing the routing (interconnect) components, each defined within a 2^{N}—dimensional Hilbert space for an N qubit system; (iii) a system defect Hamiltonian constructed by the sum of all undesired effects, such as crosstalk, of the placement and routing components within the system; (iv) a bath Hamiltonian describing all specified environmental noise sources; and (v) a system-bath coupling Hamiltonian describing the coupling of the bath Hamiltonian to the operator basis of the N qubits. In one embodiment, the operator basis expansion 130 of the effective Hamiltonian is attained from a second-quantized Hamiltonian using either the Schrieffer-Wolf transformation or some other mapping scheme.

Given that each of the predefined coefficients preceding the Pauli operators has some variation, users can optionally statistically interpret the effect of this variation on the coefficients of the effective Hamiltonian. This is achieved by sampling the user-defined coefficients from an appropriate distribution (e.g., Gaussian) and running open quantum system simulations over all chosen configurations of the sampled coefficient. For each configuration, a new effective Hamiltonian must be constructed prior to running open quantum system simulations. By evaluating the mean values and variances (and possibly higher distribution moments) of the performance metrics, users will have an indication of how their faulty placement and routing components affect the overall functionality of their qubit architecture design.

Open Quantum System simulator: Open quantum system simulators, or quantum simulators, are required to assess the operational performance of quantum computing architectures. Within the framework of quantum computing, a closed (i.e., isolated) quantum system's external environment is accounted for using a formal framework known as open quantum systems (OQS). OQS incorporate environmental noise by appropriately modifying the Schrodinger or quantum Liouville equation. The result is called a quantum master equation. Other ways to incorporate environmental noise include quantum Monte Carlo (QMC) and tensor networks (TN).

QDA system 100 makes use of a highly scalable (with the number of qubits) open quantum system simulator 116 to assess the operational performance of a multi-qubit quantum computing platform. Open quantum system simulator 116 simulates arbitrary time-dependent Hamiltonians with a variety of noise sources. This involves considerations of the environment in which the qubits operate. Different qubit types may involve considerations of different noise sources. By way of example, semiconductor qubits have three main sources of noise from their environment: 1/f charge noise, spin dephasing due to hyperfine interactions, and phonon-mediated relaxation.

In one embodiment, the present system makes use of the Hamiltonian Open Quantum System Toolkit (HOQST) described by Chen, H. and Lidar, D. A., “HOQST: Hamiltonian Open Quantum System Toolkit,” Commun. Phys. v. 5, p. 112 (2022). HOQST is a unique solver that simulates arbitrary time-dependent Hamiltonians with a variety of noise sources, including ohmic baths (for example, in Si/SiGe lateral quantum dot spin qubits, this noise models phonon-mediated relaxation that occurs due to the emission of acoustic phonons coupled to a spin-mixing relaxation such as hyperfine or spin-orbit) and 1/f charge noise (for example, in Si/SiGe lateral quantum dot spin qubits, this noise plays a dominant role and can be accounted for using a spin-fluctuator model). As opposed to many gate-based approaches to OQS, HOQST accounts for the continuous driving of quantum systems due to the finite bandwidth of signal generators and controllers. In some embodiments of the present system, HOQST is modified through the introduction of tensor networks (TN) 132, Quantum Monte Carlo (QMC) schemes 134, sparse representation 136, and/or alternative propagation methods to provide a scalable open quantum system simulator.

More generally, open quantum system simulator 116 is configured to handle quantum dynamics, which is the most accurate but is also a costly approach to OQS. Solving a quantum master equation, which requires storing and evolving the full 2ⁿ×2ⁿ density matrix, is feasible for up to about n=15 qubits, beyond which even the largest supercomputers run out of memory. This number can be doubled using the stochastic Schrodinger equation or quantum trajectory approaches, which only store and time-evolve pure quantum states of dimension 2ⁿ, not the full density matrix, for the price of running many (but parallelizable) trajectories. To go beyond n=30 qubits or so, further approximations must be made, or equilibrium properties must be calculated instead of dynamics. As noted, within open quantum system simulator 116, this is done by introducing TN 132, QMC 134, sparse representation 136, and/or other propagation methods. TN 132 introduces an entanglement cutoff parameter known as the bond dimension. In terms of scalability, the lower the bond dimension, the larger the number of qubits that can be handled, until the system being described is essentially classical in the limit of no entanglement. A bond dimension that accounts for a sufficient amount of entanglement can result in the consideration of up to thousands of qubits. Interpolating between the high entanglement/low qubit number and low entanglement/high qubit number limits can be done systematically, and the optimal point along the interpolation depends to a large extent on how noisy the environment is. Similar consideration apply to QMC, where the relevant parameter is the temperature. The lower the temperature, the more costly the simulation is. For sufficiently high temperatures, simulations involving hundreds of qubits are feasible.

Parallelization is another frontier for scaling up the open quantum system simulator 116. In various embodiments, this may include utilizing high performance computers (HPC), graphic processing units (GPUs), message passing interfaces (MPI), and open multi-processing (OpenMP) techniques.

Master Equations: Among the different classes of master equations 136 that may be incorporated into open quantum system simulator 116 are the time-independent Lindblad equation, the time-dependent (adiabatic) Lindblad equation, the Redfield equation, the polaron-transform Redfield equation, the stochastic Schrodinger equation, the universal Lindblad equation, and the coarse-grained master equation. Two of these, namely the stochastic Schrodinger equation and Redfield equation are described below.

Stochastic Schrodinger Equation: The N-qubit Schrodinger equation: |ψ [symbol] =−iH(t)|ψ [symbol] , is a set of D=2^{N} linear ordinary differential equations (ODE) with D complex variables. For the present discussion, we focus on the case where H(t) is time dependent. In one embodiment, open quantum system simulator 116 uses ODE solvers. The main idea of any ODE solver is to discretize the time and propagate the state for a small-time interval dt each time. The time-complexity per step is mainly the complexity of evaluating the matrix vector multiplication (for explicit method), with the complexity given by O(D²).

For example, assume it takes 5 ns to do a multiplication for two double-precision complex numbers. Then for a 16-qubit problem, a single step in the ODE solver takes ˜2³²×5×10⁻⁹≈21 s. It is hard to estimate how many times steps are needed a priori because it is highly case dependent. A very conservative estimation is to choose step size which is smaller than

$$1 / {‖ H ‖}_{max}^{2} where {‖ H ‖}_{max} = {max}_{t} ‖ H ( t ) ‖ and ‖ \cdot ‖$$

is the spectral norm. However, this will be too conservative for most practical applications. Nevertheless, if 1000 steps are needed, the algorithm will take around 6 hours. Also at this point, the memory becomes a bottleneck. The memory required to store one copy of the Hamiltonian is

$${2}^{32} \times \frac{16}{{10}^{9}} \approx 70 GB ,$$

which for many workstations is at or near capacity.

Redfield Equation: The adiabatic master equation (AME) is harder to simulate than the Lindblad equation, mainly because it requires an eigenvector decomposition of the instantaneous system Hamiltonian at each time step. For a single AME step, the main bottleneck would be to evaluate the right hand side (RHS) of the following expression:

$$\dot{ρ} = - i [ {H}_{S} + {H}_{LS} , ρ ( t ) ] + {\sum }_{αβ , ω} {γ}_{αβ} ( ω ) ( {L}_{ω , β} ρ {L}_{ω , α}^{†} - \frac{1}{2} \{ {L}_{ω , α}^{†} {L}_{ω , β} , ρ \} )$$

The first step is to perform the eigen-decomposition of the Hamiltonian Hₛ, which has a complexity of O(D³). Next, the density matrix is rotated into the eigenbases of the Hamiltonian, which is equivalent to 2 matrix multiplications and has a time complexity of O(D³). For simplicity, we ignore the Lamb shift term H_{LS}. Now in the frame of the Hamiltonian, the Hamiltonian is diagonal. So, the Hamiltonian and density matrix multiplication has order O(D²).

The next step is to calculate the Lindblad term. Assuming that there are only a constant number of single-qubit-system-bath coupling operators for each system qubit, then for each single-qubit system bath coupling operator, the corresponding Lindblad terms

$${ℒ}_{α} [ ρ ] = {\sum }_{ω} {γ}_{α} ( ω ) ( {L}_{ω , α} ρ {L}_{ω , α}^{†} - \frac{1}{2} \{ {L}_{ω , α}^{†} {L}_{ω , α} , ρ \} )$$

has the complexity of O(D²). To see this, we break down the operations needed to calculate [symbol] _{α}[ρ]. First, rotating a single-qubit system-bath-coupling operator into the Hamiltonian eigenbasis requires O(D²) operation because a single qubit operator is sparse. Second, assuming every non-zero gap is unique, there are O(D²) corresponding rank-1 Lindblad operators. There is also a single Lindblad operator corresponding to the zero gap which is diagonal. In both cases it requires O(D²) multiplications to calculate the corresponding summand. Finally, to rotate p back into computational basis requires O(D³). In short, the main operators to evaluate the RHS has a time complexity of O(D³)+O(D²). Note, however, the prefactor could vary depending on the implementation. We can estimate the running time by considering only the leading order term O(D³) and scaling it by the minimum number of O(D³) steps, i.e., 5 in this case. For 10 qubits, a single ODE step could take ˜5×2^{3×10}×5×10⁻⁹≈27 s. Thus, we can solve a 10-qubit AME in a time of the order of hours.

Noise Modeling: In one embodiment, open quantum system simulator 116 incorporates three prominent sources of noise 138 from the environment: 1/f charge noise, spin bath, and Ohmic bath. Charge noise plays a dominant role in all solid-state devices, including superconducting qubits and isotopically purified Si/SiGe spin qubits, and is modeled within open quantum system simulator 116 by the spin-fluctuator model. A spin bath can be defined by introducing additional qubits to fictitiously represent the spins in the environment. More qubits result in a better representation of the spin bath at the cost of increased computational complexity. For Si/SiGe spin qubits, nuclear spin baths tend to be computationally burdensome due to the large relaxation time of nuclear spins, resulting in long simulation times to account for their dynamics. As for noise model parameters, only close comparisons to experiments or simulations (approximating the physical noise of the system) can ensure that the noise sources are accurately represented.

Sparse Representation: Sparse representation 136 of the effective Hamiltonian can further improve the scalability of open quantum system simulator 116. This can be achieved by using either a sparse representation of the matrix or a matrix-free method such as that of C. Rackauckas and Q Nie. “Differential equations j1—A Performant and Feature-Rich Ecosystem for Solving Differential Equations in Julia,” Journal of Open Research Software 5:15 (2017). Assuming the Hamiltonian has a row sparsity m, the time complexity of one ODE step is O((1−m)D²) or even O(poly(N)D) if the Hamiltonian has only a local structure. In the latter case, the limit could be pushed to 20-32 qubits with a run time of hours (32 qubits just to recover the previous number of 2³²).

Quantum Monte Carlo: QMC 134 can be used to provide computationally tractable solutions of many-body open quantum systems by efficiently evaluating their multi-dimensional integrals. QMC does not describe dynamics but samples from the equilibrium quantum Gibbs distribution instead. That is, it provides spin configurations with a probability that matches the underlying quantum Gibbs distribution. These spin configurations can be used to estimate expectation values of arbitrary quantum observables. QMC can be understood as a method that replaces a D-dimensional quantum spin system by a D-dimensional classical spin system plus an extra imaginary time dimension. The latter corresponds to the temperature of the quantum spin system; the lower the temperature, the longer the imaginary time axis, meaning that the simulation takes longer to complete. QMC methods can easily handle hundreds and even thousands of qubits while retaining a full quantum description (i.e., they do not involve an approximation as in the TN case), and they can be adapted to sample from an adiabatically (slowly) evolving system using an approach known as simulated quantum annealing (SQA). The one weakness of QMC is that it suffers from the so-called sign problem, which essentially means that it cannot handle fermionic systems, or qubit systems with so-called non-stoquastic Hamiltonians. This limits the class of quantum systems for which QMC can be applied, but it remains an exceptionally powerful tool in many relevant applications.

In various embodiments, different QMC methods, including Variational Monte Carlo, Diffusion Monte Carlo, Auxiliary-field Monte Carlo, Path Integral Monte Carlo, Time-Dependent QMC, among others, may be employed. Equipped with parallelization techniques, qubit states of significantly more complex quantum circuits (>10³ qubits) can be sampled directly rather than evaluated using open quantum system simulations. Furthermore, tensor networks can be integrated into certain QMC methods (e.g., Variational Monte Carlo) to provide further scalability in the number of qubits.

Tensor Networks: The ability for TN 132 to speed up computation lies in the fact that it admits a compressed representation of quantum state or operators. One of the most well-known and best understood tensor networks is the matrix product state (MPS) or tensor train (TT). It is a type of tensor network that is particularly useful for simulating one-dimensional quantum systems, like quantum chains. The key idea behind an MPS is to express a high-dimensional object (like a quantum state) in terms of a network of lower-dimensional tensors, which can be manipulated more easily. A generalization of MPS to an arbitrary graph (i.e., beyond one-dimensional graphs) is the projected entangled pair states (PEPS) method. At a computational cost that scales polynomially, PEPS is a generalization of MPS for two and higher dimensional quantum systems as described by R. Orús, “A practical introduction to tensor networks: Matrix product states and projected entangled pair states,” Annals of Physics 349 (2014): 117-158.

In the context of a quantum system, one typically starts with a quantum state of N particles, each with a d-dimensional Hilbert space (for qubits, d=2). The state of this system can be described by a vector in a (d^{N})-dimensional Hilbert space, which becomes exponentially large as N increases. In an MPS, this state is expressed as a product of matrices. Specifically, each particle i is associated with a set of D matrices

$$\{ {A}_{s}^{i} \} ,$$

where s ranges from 1 to d and D is the “bond dimension.” Each matrix

$${A}_{s}^{i}$$

of size D-by-D, except for the first and last matrices which are D-by-1 and 1-by-D vectors, respectively.

The coefficients of the quantum state (in some basis) are then given by the product of these matrices, with the product taken over all particles and the index s chosen according to the state of each particle. This product forms a sort of chain of matrices, which is why MPS is particularly suited to one-dimensional systems.

The benefit of the MPS representation is that it is much more efficient than the full Hilbert space representation for states that are only slightly entangled. The bond dimension D controls the amount of entanglement that can be captured by the MPS: a larger D allows for more entanglement, but also requires more computational resources. To store a tensor train with bond dimension D requires only NdD² complex numbers. If the quantum system has low entanglement, the storage requirement scales linearly with respect to the system size (against 2^{N}).

One important time evolution algorithm for tensor train is the Time-Evolving Block Decimation (TEBD) algorithm. The approach is to apply the Trotterization technique to the evolution, breaking it down into local “gates” such that they are cheap to apply. For instance, in the case of an alternating-sector chain problem, the Hamiltonian is given by:

$$H = - A ( t ) {\sum }_{i} {X}_{i} - B ( t ) {\sum }_{i} {w}_{i} {Z}_{i} {Z}_{i + 1} .$$

The first order Trotterized evolution operator for a small-time step Δt is:

$${e}^{- iH Δ t} \approx {e}^{\frac{{iAX}_{1}}{2}} {e}^{\frac{{iAX}_{2}}{2}} … {e}^{\frac{{iAX}_{N}}{2}} {e}^{\frac{{iBw}_{1} {Z}_{1} {Z}_{2}}{2}} {e}^{\frac{{iBw}_{2} {Z}_{2} {Z}_{3}}{2}} … {e}^{\frac{{iBw}_{N - 1} {Z}_{N - 1} {Z}_{N}}{2}} .$$

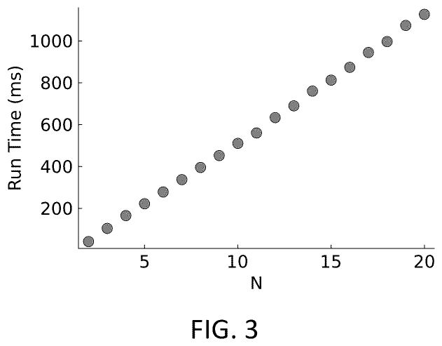

Each term in this equation signifies a local gate acting on the quantum state. In general, when the quantum state is represented as a Matrix Product State (MPS) with a bond dimension capped at D, the computational cost to evolve the state for one-time step is on the order of O(NdD³) (here it is assumed the number of terms in the Hamiltonian scales linearly with the number of qubits). By way of example, using the ITensor library (M Fishman, S White, and E Stoudenmire. “The ITensor software library for tensor network calculations,” SciPost Physics Codebases (2022): 004) to solve the Schrodinger equation with a time step Δt=0.1 and total evolution time as t=100 (thus employing a fixed time-step algorithm with 1000 steps), the plot shown in FIG. 3 demonstrates the runtime as a function of the system size.

Any of several time evolution algorithms for tensor networks suitable for simulating quantum systems may be employed in open quantum system simulator 116. For example:
Time-Evolving Block Decimation (TEBD): This algorithm works well for simulating time evolution in one-dimensional systems. It operates by Trotterizing the Hamiltonian and applying local gates sequentially to evolve the state. The bond dimension of the tensor network controls the computational cost and precision of the simulation. Its time complexity is O(NdD³).
Time-Dependent Variational Principle (TDVP): This is a versatile method used to simulate the real and imaginary time evolution of Matrix Product States (MPS). TDVP does not require Trotterization of the Hamiltonian and can be applied to finite or infinite systems, conserving certain quantities like energy or particle number more accurately. The time complexity is the same as TEBD O(NdD³).
Simple Update Algorithm: This is a real-time evolution algorithm for Projected Entangled-Pair States (PEPS). It works in two dimensions and applies a local update to the tensor network that keeps the bond dimension fixed. Since this algorithm is designed for 2-D system, the complexity is O(d²D⁶).
   Note, these are estimates and the actual complexity may depend on details of the system, the algorithm, and other factors. Note also that the bond dimension D is often chosen adaptively in these algorithms, based on a balance between accuracy and computational resources, and it can increase during the simulation for dynamic methods.

Performance Metrics: As mentioned, defining a sufficient set of performance metrics is important in order to provide the user with a reliable understanding of their quantum component(s) and/or quantum circuit. For simulation purposes, it suffices to focus on the fidelity of qubit storage, the fidelity of gate operations, initialization fidelity, and the readout fidelity. Achieving high 9's, at least to the first decimal point, for all fidelities ensures that fault-tolerant quantum error corrections requirements are met, thus providing a clear path to scalability of the quantum computer design in question. In this respect, the present system provides a fidelity map of all possible qubit operations within the user prescribed quantum computing architecture.

System Characterization: To automatically refine the open quantum system simulator 116 for a particular qubit architecture, a characterization procedure can be utilized. System characterization module 160 receives as inputs experimental data 105. The experimental data represents a collection of all possible qubit operations for a particular qubit architecture, as well as the qubit's stability (e.g., relaxation time, dephasing time). Prior to running quantum simulations, this data is compared with noise-free open quantum system simulations using machine learning and fitting procedures 162 to, for example, prescribe the appropriate master equation(s), fine tune the noise model parameters, and define an appropriate temperature or bond dimension D for QMC and TN schemes, respectively.

Quantum Control: Quantum control aims to optimize the control signals of quantum computing architectures by maximizing performance metrics. In the case of semiconductor-based qubits, for example, quantum control allows a user to optimize the voltages applied to the physical gates above the semiconducting heterostructure to ensure maximal qubit performance. More generally, performance metrics may be maximized by optimizing the (time-dependent) coefficients of the effective Hamiltonian's operator basis expansion by targeting a selected cost function. The cost function can be any of the performance metrics, such as the fidelity of a given qubit operation. Quantum control can therefore provide a powerful indication of the control signals required for high-fidelity qubit operations, eliminating the time and uncertainty of manually tuning control signals.

In various embodiments, existing quantum control protocols tailored towards optimizing control signals, such as Chopped RAndom Basis (CRAB) 142, GRadient Ascent Pulse Engineering (GRAPE) 144, and Krylov subspace approach 145, implementations of which are available through open-source software libraries, are used. Other quantum control protocols may also be used. Examples of these include other methods developed within Optimal Control Theory, such as direct collocation method, direct transcription method, indirect methods, and Coherent Control, along with methods developed within the framework of Bang-Bang Control, Open-Loop Control, Closed-Loop Control, Composite Pulses, Dynamic Decoupling, Feedback Stabilization, and Machine Learning and Reinforcement Learning techniques. As shown in FIG. 1, these processes are used iteratively with the open quantum system simulator 116 to adjust the control signals to optimize the expansion coefficients of the effective Hamiltonian and thereby determine optimized control signals 114 that maximize the performance metrics of a given qubit architecture.

In other embodiments, the expansion coefficients of the effective Hamiltonian may be self-determined for an existing quantum computing platform by using fitting procedures or supervised machine learning techniques so that hardware developers do not have to manually input their coefficients of their operator basis expansion. Similarly, such techniques can be used to automatically characterize the noise model parameters of a given quantum computing architecture.

Analysis and Verification: The analysis and verification procedures 128 are mainly tailored towards hardware developers. At first, the analysis stage discerns the reliability of the user's system design and modify the design given a set of predefined constraints. The described QDA tool seeks to enable the design of logical components (e.g., logical qubit, logical gate, etc.) composed of a physical qubit layout and its interconnects. A logical qubit utilizes quantum error correction schemes such as surface codes to create a quantum bit that is significantly less resilient to error. Depending on the error rates of a physical qubit, the corresponding logical qubit can be composed of anywhere of a thousand or more physical qubits (for error rates ∝˜10⁻²). Given the large error rates of existing physical qubits, gates, and measurements, assessing the design and reliability of the logical components is important. One way of achieving this is by determining the failure-in-time (FIT) rate by applying different sequences of qubit operations to the graphical representation of the quantum computing platform. Ensuring a small FIT for many configurations of logical operations provides a higher level of confidence in the platform design. Once the analysis stage is complete, the verification stage runs a fault campaign by inserting faults into a circuit design to further assess the system's performance. Faults could be characterized by a variety of items, from faulty interactions between a given set of qubits due to manufacturing or physical defects, to external perturbations such as microwave fields or cosmic rays. Finally, a synthesis stage may be integrated to add reliability components to the system design for superior functionality or better fault detection.

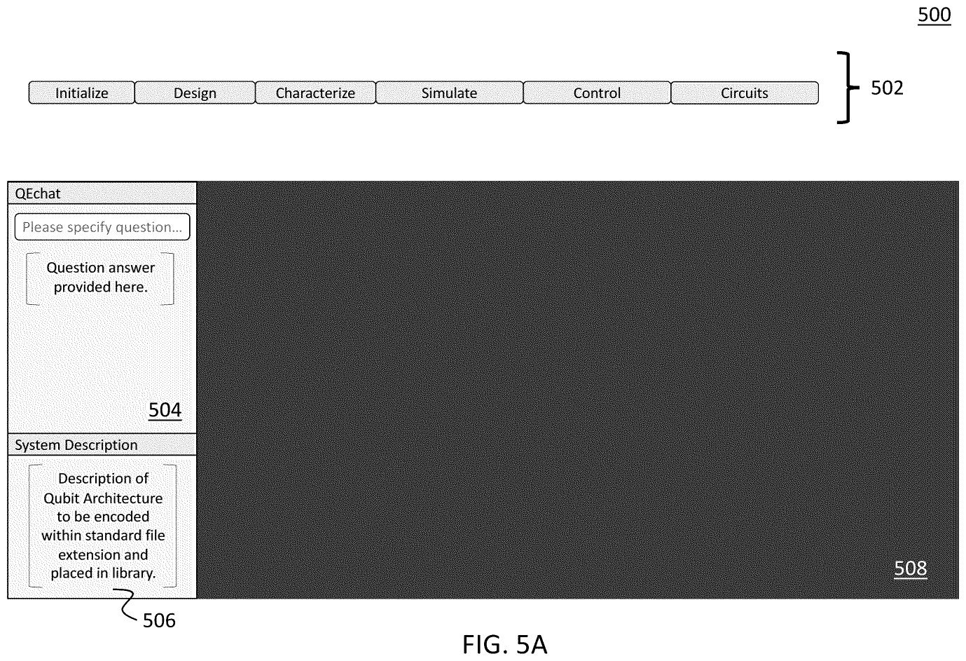

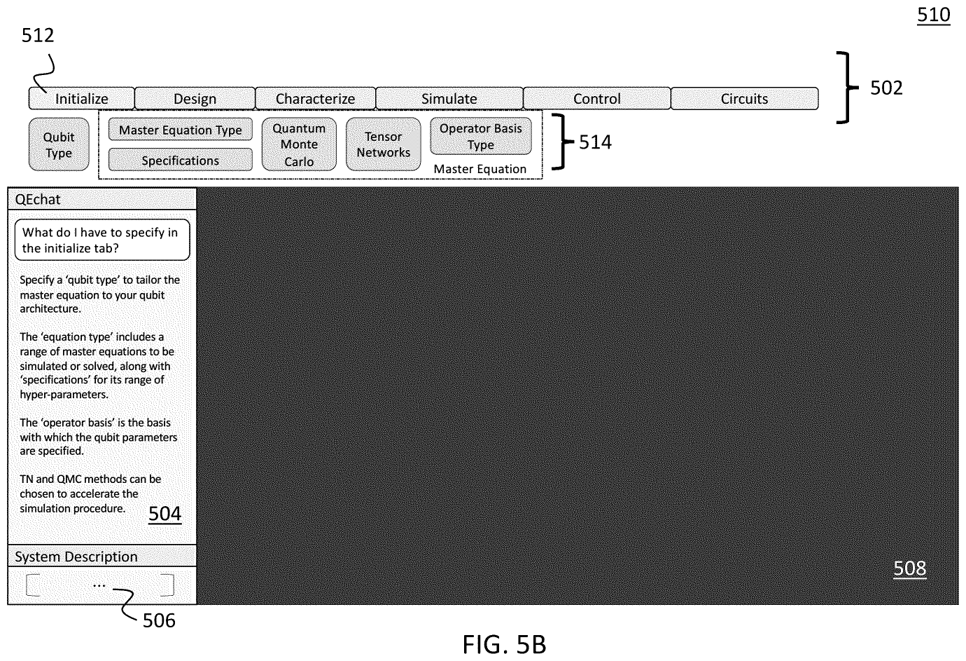

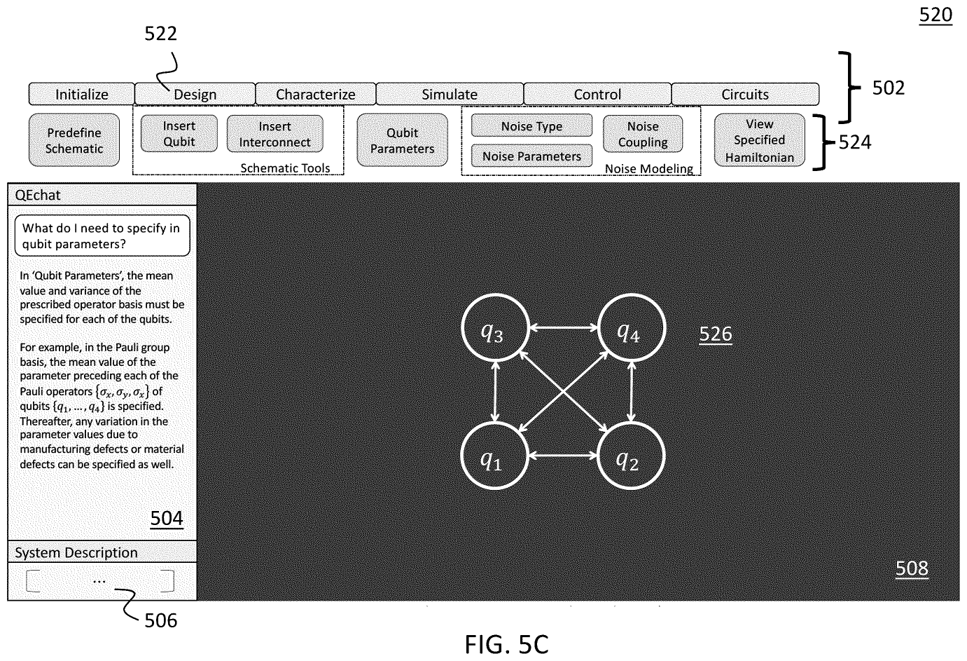

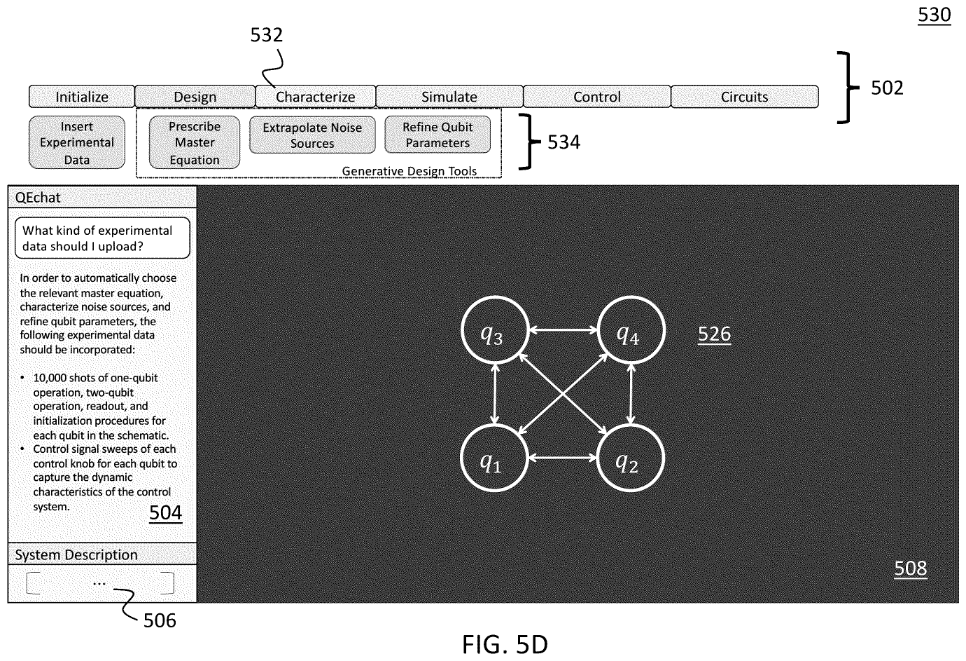

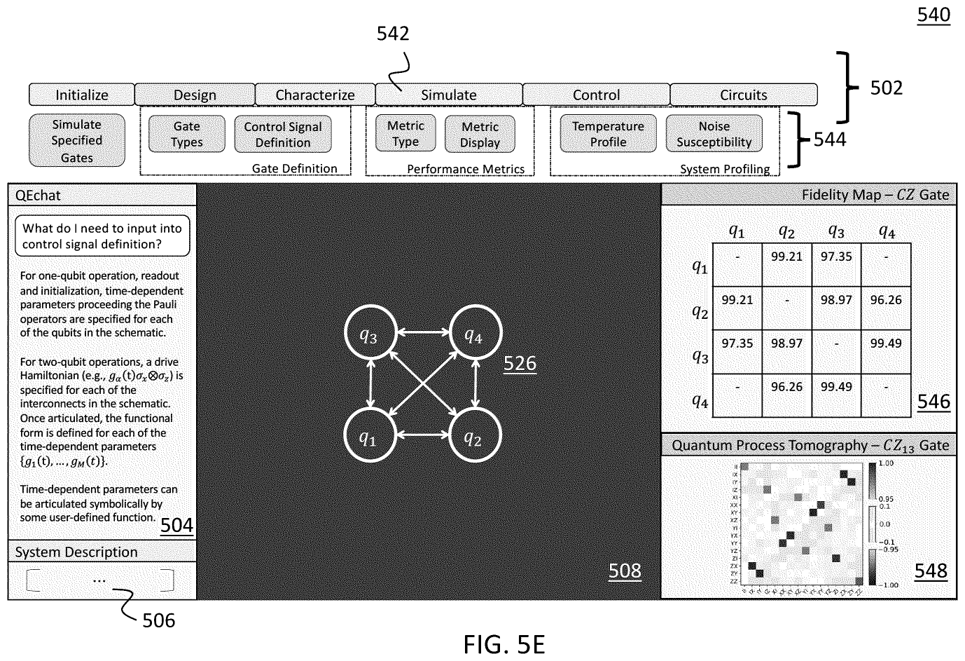

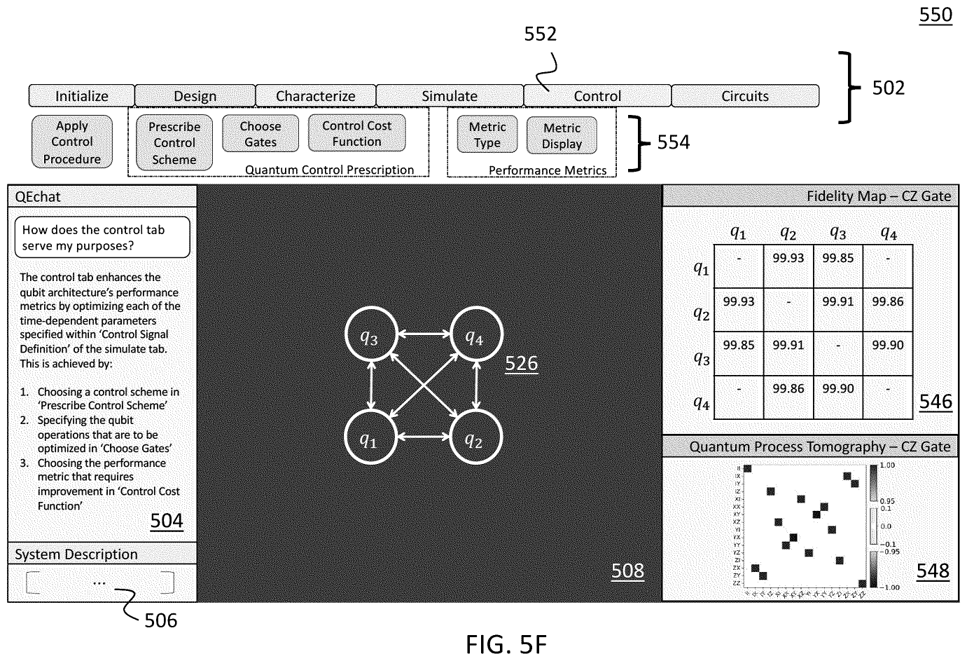

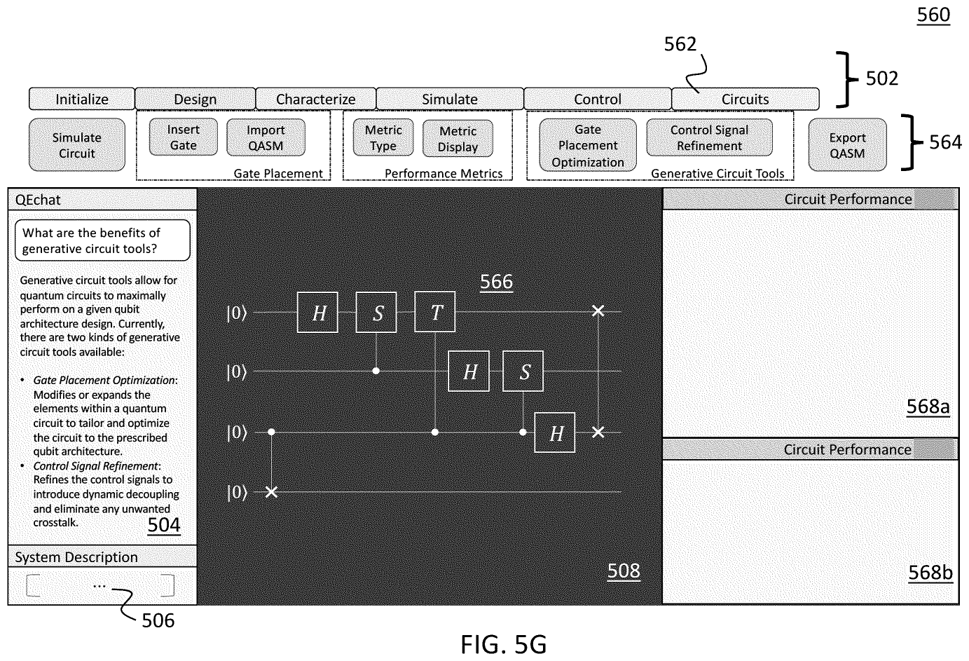

As mentioned, the present QDA system may be hosted on a computer system to allow a user to characterize and/or optimize an existing qubit-based system, store and retrieve instances of such designs, and/or verify and optimize quantum circuit representations of quantum algorithms for different qubit-based platforms and identify one or more such platforms for which various algorithms best operate. FIGS. 5A-5G illustrate examples of a user interface screens for such a computer system configured to permit such operations. These user interface screens may be presented via a display, such as display 424, to allow for the required user interaction.

In particular, FIG. 5A illustrates a user interface template 500 upon which others of the user interface screens, 510, 520, 430, 540, 550, and 560, may be based. The template 500 includes a simulation stage menu 502, which provides the user a means for selecting and a visual indication of a current simulation stage. In the illustrated example, simulation stages include an initialization stage, a design stage, a characterization stage, a simulate stage, a control stage and a circuit stage. These will be discussed individually in greater detail below. Template 500 also includes a question and answer block 504 through which a user may seek assistance with operations to be completed during each of the above-mentioned stages. And a system description block 506 is provided for textual descriptions of the qubit architecture to be simulated. Finally, a display field 508 is used for visual displays of the qubit architecture under review.

FIG. 5B illustrates an example of an initialization screen 510 of the present user interface. Initialization screen 510 may be selected through the Initialize option 512 of menu 502, which may be highlighted upon such selection. Initialization screen 510 includes a submenu 514 that allows for specification of qubit type (e.g., Transmon, Fluxonium, Flux (CSFQ), Trapped Ion, Neutral Atom, Silicon Photonic, SiMOS lateral quantum dot spin qubit, SiGe lateral quantum dot spin qubit, diamond nitrogen vacancy center spin qubit, donor spin qubit, etc.), e.g., using a drop-down menu or other common form of selection indicator. Selection of a qubit type will automatically populate a form of master equation to be used and the user is prompted to provide an operator basis type and specifications therefor. Equation types may include a Lindblad equation, adiabatic master equation, Redfield equation, polaron-transformed Redfield equation, stochastic Schrodinger equation, universal Lindblad equation, or coarse-grained master equation. An operator basis type may be, for example, the Pauli group operator. Other possible operator basis types include generalized Gell-Mann and Unit metrices. Specifications may include relevant parameters for the prescribed master equation. For example, for superconducting qubits defined by polaron-transformed Redfield equation, relevant parameters may be the number of trajectories, relative and absolute tolerances, etc. Common user interface elements such as dropdown lists, pop-up windows, text boxes, number fields, etc. may be used to provide for the user interaction with the initialization screen 510. In addition, dropdown lists are provided for Quantum Monte Carlo and Tensor Network schemes to accelerate quantum simulations. Some of the Quantum Monte Carlo schemes include Variational Monte Carlo (VMC), Diffusion Monte Carlo (DMC), Reptation Monte Carlo (RMC), Green's Function Monte Carlo (GFMC), Auxiliary Field Monte Carlo (AFMC), Path Integral Monte Carlo (PIMC), Projected Path Integral Monte Carlo (PIMC), Constrained Path Integral Monte Carlo (CPIMC), Full Configuration Interaction Quantum Monte Carlo (FCIQMC), and Stochastic Series Expansion (SSE). Some of the Tensor Networks schemes include Matrix Product States (MPS), Matrix Product Operator (MPO), Projected Entangled Pair States (PEPS), Tensor Network Renormalization (TNR), Tree Tensor Networks (TTN), Tensor Entanglement Renormalization Group (TERG), Tensor Network Time Evolution (TNTE), Hierarchical Tensor Networks (HTN), and Tensor Network Monte Carlo (TNMC).

FIG. 5C illustrates an example of a design screen 520 of the present user interface. Design screen 520 may be selected through the Design option 522 of menu 502, which may be highlighted upon such selection. Design screen 520 includes a submenu 524 that allows for selection of any available predefined qubit architecture schematics from a stored library of such schematics (if available). If an available schematic is not available, or requires modification, the user is provided user interface elements in the form of schematic tools to insert qubits and interconnect them. As shown, the schematic representation of the qubit architecture 526 will be drawn and/or edited in display field 508. Interconnections may be specified between any two qubits, as needed. In the illustrated example, qubits are represented as circles and interconnections between qubits are represented as line segments, but any convenient forms of representations may be employed.

Submenu 524 also provides facilities for articulating qubit parameters, such as mean values and variances of coefficients within the prescribed operator basis expansion. And, noise types, noise model parameters, and noise couplings may also be specified for each of the qubits within the system. Once the necessary parameters have been specified, user selection of a “View Specified Hamiltonian” button (or other interface element) will allow the user to view the qubit architecture's coefficients and noise model parameters through the graphical user interface.

FIG. 5D illustrates an example of a characterize screen 530 of the present user interface. Characterize screen 530 may be selected through the Characterize option 532 of menu 502, which may be highlighted upon such selection. Characterize screen 530 includes a submenu 534 that allows for uploading of experimental data, as described above, for example through a pop-up window or other data entry element. Also, user interaction with design tools for automatically generating a master equation, extrapolating noise sources, and refining the operator basis coefficient values are provided for through user interface elements such as buttons. Initiation of a generative design tool through selection of a corresponding button of the user interface may cause a pop-up window specific to that tool to be displayed when the associated action has been completed in order to provide the user an indication of successful completion of the requested task.

FIG. 5E illustrates an example of a simulate screen 540 of the present user interface. Simulate screen 540 may be selected through the Simulate option 542 of menu 502, which may be highlighted upon such selection. Simulate screen 540 includes a submenu 544 that allows for user specification of gate types, control signal definition, and performance metrics. Gate types may be selected through user interface elements such as drop down menus or checkboxes used with lists of available options. Control signal definition may be made via similar user interface elements. For each interconnect or a collection of interconnects, the user is asked to specify a drive and qubit-qubit interaction Hamiltonian for chosen gates and to specify coupling terms (e.g., by selecting from available ones thereof). Time dependent parameters for each coupling parameter can also be specified. For performance metrics, both metric type and metric display options may be selected. Among the metric types that may be chosen (e.g., via drop down menu or checkbox list) are gate fidelity maps, quantum process tomography, relaxation time, dephasing time, cross-talk, leakage, measurement fidelity, non-Markovianity measure, etc. Shown in the illustration is an example of a fidelity map 546 and quantum process tomography 548 for a CZ gate applied between control qubit 1 and target qubit 3. These maps and tomographies may be generated once the gate types and performance metrics have been specified, for example, through user selection of a “simulate specified gates” button or other user interface element. In addition to the above, submenu 544 includes user interface elements for generating system profiles such as a temperature profile and/or a noise susceptibility profile. These profiles may be displayed as plots in the areas occupied by the fidelity map and quantum state tomography in the current illustration or in other areas of the user interface, either on control screen 540 or another screen.

FIG. 5F illustrates an example of a control screen 550 of the present user interface. Control screen 550 may be selected through the Control option 552 of menu 502, which may be highlighted upon such selection. Control screen 550 includes a submenu 554 that allows the user to prescribe a control scheme and to choose gates (e.g., CZ, CNOT, Hadamard, X, Y, Z, Phase, T, SWAP, iSWAP, fSim, Molmer-Sorensen, Rydberg blockade, Heisenberg exchange) and a control cost function (e.g., gate fidelity map). After such prescriptions and selections (which may be made through appropriate user interface elements such as drop down menus, check box lists, etc.), the user can apply the control procedure with specified performance metrics such as those mentioned above.

FIG. 5G illustrates an example of a circuits screen 560 of the present user interface. Circuits screen 560 may be selected through the Circuits option 562 of menu 502, which may be highlighted upon such selection. Circuits screen 560 includes a submenu 564 that allows for user specification of gate placement and performance metrics. In this screen, the display field 508 is populated by a circuit diagram 566 drawn according to the user-specified gate placement. The user is provided interface tools for specifying gate type and placement, with each gate being defined through the simulate and control screens. In some embodiments, circuits may be defined by uploading a QASM file. And, various performance metrics may be defined.

Selecting a “simulate circuit” button or similar interface element causes the circuit represented in display field 508 to be simulated for the specified qubit architecture. Tools are provided to allow the user to have the system automatically optimize gate placement and refine control signals and then export the resulting QASM file that defines the optimized circuit. And fields 568a, 568b are provided for reporting circuit performance measures.

Thus, systems and methods for the analysis, synthesis, and verification of quantum computing architectures have been described.

What is claimed is:

1. A quantum design automation (QDA) system comprising a processor and a memory communicatively coupled to the processor, the memory storing instructions, which when executed by the processor cause the processor to provide a set of performance metrics for each of a plurality of qubit operations of a specified qubit architecture from an effective Hamiltonian for the specified qubit architecture and to additionally provide a set of control signals for the specified qubit architecture which maximize the performance metrics for a prescribed cost function based on one or more of the performance metrics.

2. The QDA system of claim 1, wherein the effective Hamiltonian for the specified qubit architecture is produced from (a) the specified qubit architecture's placement and routing components; (b) coefficient values for an operator basis expansion of a chosen operator basis representation; (c) time-dependent coefficients within the operator basis expansion for application of qubit operations; (d) undesired crosstalk parameters relevant to the routing components within the specified qubit architecture; and (e) noise sources relevant to the specified qubit architecture and their respective noise model parameters.

3. The QDA system of claim 2, wherein (a) the specified qubit architecture's placement and routing components; (b) the coefficient values for the operator basis representation; (c) the time-dependent coefficients within the operator basis expansion for the application of qubit operations, (d) the undesired crosstalk parameters relevant to the routing components within the specified qubit architecture; (e) the noise sources relevant to the specified qubit architecture and their respective noise model parameters; and (f) experimental data representing qubit stability and all possible qubit operations for the specified qubit architecture are accepted by the QDA system through a user interface.

4. The QDA system of claim 2, wherein the effective Hamiltonian for the specified qubit architecture is defined by a sum of: (i) a system Hamiltonian constructed by a tensor product of an operator basis expansion of N qubits; (ii) an interaction Hamiltonian constructed by a sum of all drive and qubit-qubit interaction Hamiltonians describing the routing components, each defined within a 2^{N}-dimensional Hilbert space for an N qubit system; (iii) a system defect Hamiltonian constructed by a sum of all undesired effects of the placement and routing components; (iv) a bath Hamiltonian describing all specified environmental noise sources; and (v) a system-bath coupling Hamiltonian describing a coupling of the bath Hamiltonian to the operator basis expansion of the N qubits.

5. The QDA system of claim 4, wherein the operator basis expansion of the effective Hamiltonian is computed from a second-quantized Hamiltonian using either the Schrieffer-Wolf transformation or another mapping scheme.

6. The QDA system of claim 1, wherein the QDA system is further configured to accept a quantum circuit describing an algorithm along with constraints relating thereto and assess performance metrics of the algorithm within the specified qubit architecture.

7. The QDA system of claim 6, wherein the constraints of the quantum circuit include circuit depth and circuit width.

8. The QDA system of claim 6, wherein the performance metrics can be used to further improve the algorithm by modifying the quantum circuit.

9. The QDA system of claim 1, wherein the QDA system is further configured to provide for selection of one or more characterized qubit architectures from a library of qubit architectures and to facilitate simulated execution of a quantum algorithm or quantum circuit on selected ones of the qubit architectures from the library by producing performance metrics for the selected ones of the qubit architectures according to a set or sequence of qubit operations.

10. The QDA system of claim 1, wherein a mean value, variance, and higher order moments of the performance metrics are produced by an open quantum system simulator that is configured to statistically interpret variations in the coefficients, if any, contained within the effective Hamiltonian.

11. The QDA system of claim 10, wherein for each of a plurality of iterations of the open quantum system simulator, successive effective Hamiltonians are constructed from different configurations of coefficients, per specified variations of the coefficients, if any.

12. The QDA system of claim 10, wherein the open quantum system simulator is a solver or set of solvers that simulates arbitrary time-dependent Hamiltonians with a variety of noise sources.

13. The QDA system of claim 10, wherein the open quantum system simulator is configured to determine the performance metrics using an Open Quantum Systems framework modified by one or more of tensor networks, Quantum Monte Caro, and sparse representation methods.

14. The QDA system of claim 12, wherein the open quantum system simulator incorporates one or more noise models.

15. The QDA system of claim 14, wherein the noise models include one or more of: 1/f charge noise, spin bath, and Ohmic bath.

16. The QDA system of claim 10, wherein the open quantum system simulator is characterized for a particular qubit architecture by using machine learning and fitting procedures to prescribe an appropriate master equation, fine tune the specified qubit architecture's noise model parameters, refine static and time-dependent coefficients defined within the operator basis expansion of the system, determine any unwanted crosstalk within the system, and define a temperature or a bond dimension, D, for Quantum Monte Carlo QMC and Tensor Network schemes, respectively.

17. The QDA system of claim 1, wherein the control signals are optimized according to one or more quantum control protocols.

18. The QDA system of claim 17, wherein one or more quantum control protocols include methods developed within Optimal Control Theory, such as Chopped RAndom Basis (CRAB), GRadient Ascent Pulse Engineering (GRAPE), direct collocation method, direct transcription method, indirect methods, Coherent Control, Krylov subspace approach among others, along with methods developed within the framework of Bang-Bang Control, Open-Loop Control, Closed-Loop Control, Composite Pulses, Dynamic Decoupling, Feedback Stabilization, and Machine Learning and Reinforcement Learning techniques.

19. The QDA of claim 1, wherein the QDA system is further configured with analysis, synthesis, and verification protocols to enhance performance and ensure reliability of the qubit architecture's design.
